(19) United States
(12) Patent Application Publication
(10) Pub. No.: US 2009/0144821 A1
(43) Pub. Date: Jun. 4, 2009

(54) AUXILIARY METHOD FOR INVESTIGATING LURKING PROGRAM INCIDENTS

(75) Inventors: HSING-KUO WONG, TAO-YUAN COUNTY (TW); YI-BIN LU, TAO-YUAN COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: CHUNG SHAN INSTITUTE OF SCIENCE AND TECHNOLOGY, ARMAMENTS BUREAU, M.N.D., TAOYUAN COUNTY (TW)

(21) Appl. No.: 11/948,168

(22) Filed: Nov. 30, 2007

(51) Int. Cl. G06F 11/30

(52) U.S. Cl. 726/22

(57) ABSTRACT

An auxiliary method for investigating lurking program incidents is disclosed. The method is to keep monitoring a plurality of processes run by a computer system and save process-invoking relationship data of each process being monitored when the process is created and terminated. Simultaneously, a system registry database of the computer system is also monitored and autostart-registered data of the programs is saved. Then correlate the process-invoking relationship data to the autostart-registered data for generating and saving process-invoking relationship log so as to extract and save high-level crucial clues of suspicious lurking programs. By the present method, only a little amount of high level crucial clues and process-invoking relationship log is collected and a few system resources is consumed for providing clear evidence that is helpful to investigation of lurking program incidents. Thus cost of time and labor for collecting and analyzing large amount of low-level logs is saved.

### BACKGROUND OF THE INVENTION

The present invention relates to an auxiliary method for investigating lurking program incidents, especially to a software method that is helpful to investigation—incidents caused by lurking programs.

A lurking program is a malicious program that is installed and hidden in a computer system for receiving commands from hackers so as to carry out unauthorized activities. The typical unauthorized activities are divided to various kinds according to their purposes: (1) Capturing the user's keystrokes such as a Keylogger. (2) Stealing personal private data such as credit card numbers, account numbers or important document files. (3) Hijacking a Web browser for forcing users to read advertisements or porn Web-sites. (4) Installing some malicious programs so as to proceed to do more illegal activities or even to perform as a stepping stone to attack other computers. (5) Connecting with other lurking programs in other computers so as to form a big attack network such as a Botnet.

Besides carrying out illegal activities according to opportunities or commands, lurking programs have several essential characteristics. (1) Automatic start-up: as soon as the computer system is booted up, the Windows Explorer or the Web browser is invoked, or even common files (such as .txt, .jpg, .mp3) are opened, it is executed automatically without any other aid of the user. (2) Intending to hide themselves: in order to avoid being discovered by Computer-Security tools (such as anti-virus or anti-spy tools), lurking programs intentionally hide themselves. (3) Connection with outsides: they will communicate with other computers, especially via the Internet, for receiving attack commands from hackers or delivering stolen data or files secretly to the hackers in remote end.

Now such kinds of lurking programs are quite popular and they are easily to be installed on remote computers when the computers are online so that personal data or important files are stolen. The programs are tools to hack data in Internet crimes and illegal activities and victims ranging from individuals, companies or government institutes. Considering the challengers the information security industry is facing today, the information security industry has three paradigms to deal with the problems: (1) To identify code signature of a lurking program and then block it. (2) To detect anomalous activities of a lurking program and block it. (3) To investigate incidents raised by lurking programs and control the damage.

Firstly, according to the lurking programs already known, extract their program signature for identification. There are many processing modes and the difference among them is in that how to create the program signature. The typical ways include computing a message digest, computing a checksum or taking pieces of code. Details of them are as followings: (a) Message digest: a hashing function is applied to a program file to compute its message digest and the message digest got is unique but the computation process is complicated and time-consuming. (b) Pieces of code: selection process of pieces of code is simple and fast. However, in order to assure its uniqueness, a lot of program files are collected in advance to form a database for comparison with the pieces. Moreover, a plurality of alternatives to take pieces of code needs to be designed for solving the problem of code collision. (c) Checksum: The program file is considered as byte stream, word stream, or multiple-word stream and the checksum of the file is calculated by the way similar to the checksum algorithm required by the communication protocol such as TCP/IP. The uniqueness and computation speed of the checksum are between the method of Message digest and pieces of code.

The detection method based on identification of the program signature has been broadly applied to information security industries for many years. Compared with non-signature based detection methods, signature based method has quite high performance. However, it is only suitable to lurking programs already known and is unable to detect lurking programs being packed. A packed program means that it is encoded and wrapped as another decoder. Due to encoding, packed programs can easily evade the detection of anti-virus tools.

Next, detecting abnormalities or execution behavior of a lurking program is to detect its essential characteristics and abnormal behavior. According to the essential characteristics analysis mentioned above, besides illegal activities, the program also has features of automatic start-up, intent to hide, and external communications. However, even these behaviors are used as criteria for judgment, detection rate and accuracy of such method are still not high due to following reasons:

(a) Nature of anomaly detection: in intrusion detection field, anomaly detection is considered with low detection rate and accuracy by academia and information security industry due to its nature—difficulty in defining normal behavior of a program.
(b) Lack of unique behavior features of a lurking program: there are three kinds of programs with functionalities of automatic star-up and external communication: (1) built-in service programs of the operation system such as Domain Name Service (DNS), Network Time Protocol (NTP), Netbios Session service, and Network Files System (NFS). (2) agents of application software, such as automatic update, database group look-up, and reporters that usually connect to their official Web-sites furtively. (3) ActiveX control required to be downloaded and installed while surfing on the Internet. There are a lot of such programs so that it's difficult to effectively detect such lurking programs accurately on the premise of lack of uniqueness. Thus an authentication mechanism for executables has received great attention to solve the problem mentioned above. However, there are no popular authentication mechanisms for executable programs' publishers and information security on the Internet. Thus generally a dialogue window pops up from the protection tools to ask whether the user agrees to execute the suspicious program, as shown in FIG. 1. Or the user needs to decide whether the browser loads a Web page embedded ActiveX controls, as shown in FIG. 2. Yet most of users are unable to make decision reasonably and correctly. Without enough information, even information security experts can't immediately decide whether a program is safe and whether to run it or not.
(c) Detecting lurking programs by security tools is easy to be evaded. Lurking programs disguise themselves as normal applications, embeds themselves into the system or masquerades as helpful components of software so as to interfere and avoid detection. Moreover, design technique of lurking programs is versatile and is improved quickly so as to escape detection by security tools available now.
(d) Difficulty in checking intent to hide: To check or judge the intent of hiding a program itself is related to human recognition while detection tool can't replace people's recognition so it is not proper to judge the intent of the program. Most of detection tools available now generate a dialogue window to ask users to make judgment. Refer to FIG. 1 again, the observation is proved.
(e) Lurking program detection is under influence of computational resources and time constraint. A lot of lurking programs will not immediately perform all illegal activities or typical behaviors once start-up or connecting to the Internet due to their nature of masking. Generally, the detection is real-time and on-line. In order to reduce system load, such detection way is not suitable for analyzing too much data or recording too many program activities. This limits its correlation capabilities and further decreases the detection rate and the accuracy.

In accordance with above analysis, low detection rate and accuracy of the behavior-based detection method is resulted from the natures of the detection technique and the characteristics of lurking programs. Therefore, in practice, the both are combined due to their complementarities. Now new lurking program detection products are rolling out on information security market but incidents related to lurking programs always keep happening. This proves that both the signature-based detection method and behavior-based detection method are not enough to detect most of lurking programs. Therefore, it is an important course that how to investigate lurking program incidents for problem solving and damage control.

There are three possible cut-in points for investigation of lurking program incidents. (1) Thorough routinely information security auditing, find out a lurking program incident and further investigate the incident. (2) Through other incidents, indirectly find out and investigate the lurking program incident. (3) Find out the lurking program incident directly and further check the incident. The difference among them is in that the nature of a lurking program to hide itself makes the users unable to find its existence and intrusion easier and earlier. In practice, after occurring some unusual events such as disclosure of confidential information of a company, the company therefore scans and inspects their E-commerce server and then may discover one or more lurking programs already hiding in the server a few months ago. The purpose for investigating lurking program incidents is to know the range of the damage and the causes of the incidents for mitigating the damage. Thus the following high-level crucial clues are required for investigating lurking program incidents:

(a) When was a lurking program installed on a computer system? Such crucial clue is represented by When-Info?
(b) What kind of program files did the lurking program include and where they were hidden? Such crucial clue is represented by Target-Info.
(c) How the lurking program was installed on the computer system? Such crucial clue is represented by How-Info.
(d) What kind of functionalities and illegal activities the lurking program owned and has done? Such crucial clue is represented by Action-Info.

In summary, the followings are the main features as well as the advantages and drawbacks of these three paradigms for dealing with lurking programs:

(1) Identify code signature and block lurking programs
(a) Major features: block lurking programs before executing or saved to the file system so as to prevent the incidents from occurring in the future.
(b) Advantages and drawbacks: this way has high detection efficiency but only useful to known and unpacked lurking programs.
(2) Detect anomalous activities of lurking programs and block them:
(a) Major features: detect and block lurking programs during their execution so as to prevent the incidents from worsening.
(b) Advantages and drawbacks: without influence of insufficient program signature while the detection rate and accuracy are relatively low.
(3) Investigate incidents of lurking programs and control the damage
(a) Major features: it can investigate incidents during or after execution of the lurking programs.
(b) Advantages and drawbacks: it covers defects of above two ways and is able to clarify up the causes of the incidents for damage control.

The purpose of investigating the lurking program incidents is to know when the lurking program is installed on a computer system (When-Info), whether the secret data is exposed or stolen (Target-Info) and functionalities as well as behaviors of the lurking programs (Action-Info and How-Info) so as to be aware of affected range, causes of the incidents and degree of damage. According to the results of investigation, security policy of personal computers and browsers could be therefore improved and then enhanced. Moreover, the code signature and behavior features of the lurking programs can be created and then applied to the signature-base detection method as well as the behavior-based detection method for further improving them.

The difficulty in investigating a lurking program incident is to extracting the mentioned three crucial clues—When-Info, Target-Info, and How-Info. As to the fourth clue—Action-Info, it could be found by detection and observation. In practice, the hidden address a lurking program registered and installed could be found after extracting the Target-Info. Thus a lurking program's files are collected. After being further tested, functionalities of the lurking program are showed and its illegal activities can also be observed. Therefore, the last clue, Action-Info, can be extracted on the basis of first three clues.

In summary, the post event survey requires advanced collection of log of program activities in details and effective correlation analysis. Because there are awful lot of executable programs in a computer system (over 3000 executable programs in Windows XP system before installing other applications), and the number of executable programs keeps increasing due to new installed software or browsing on the Internet, it is impossible to perform the investigation of lurking program incidents effectively by hand or by simple tools. Thus there is a need of effective auxiliary method for collecting and recording activity logs of executable programs, correlating, and extracting high-level clues of lurking program incidents—When-Info, Target-Info and How-Info.

During investigation of lurking program incidents, conventional software has following problems and shortcomings:

(1) Inefficient monitoring of programs in execution and their access to system resources: the techniques available now monitors all low-level activities of executable programs and their access to system resources without focused points and generates huge volume of log data, refer to FIG. 3 & FIG. 4. These routinely low-level log data may be helpful to program debug but it's useless in investigation of lurking program incidents. The reason is discussed as following. In view of feasibility, for providing crucial clues, When-Info (time of installation onto the system), Target-Info (full file name, installation path, and registered address) and How-Info (program installer and program invoker) of an executable program, the technique should be of installation-awareness. In other words, the technique needs to judge a suspicious lurking program which is being installed onto the system immediately and then generates related installation data. However, there is no such concept present in conventional techniques now. The conventional techniques record only low-level activities of programs and their access to system resources. Moreover, the techniques have to take long time and record various low-level data over 20 distinct items for extracting one instance of high-level clue triple (When-Info, Target-Info, and How-Info) from them. Without installation-view, conventional techniques generate too much log data. Not all low-level log data related to these three high-level clues is always saved by users. Even being saved, the log data may be discarded soon due to data explosion.
(2) Useless activity logs are overwhelming and wasting system resources: the operation systems provide a lot of service functions and shared system resources that result in large amount of low-level activities and very frequent accesses to system resources. For example, each window of the Windows system receives events from the system kernel very often. The Windows Explorer (explorer.exe) keeps receiving transaction events from file systems, peripherals, the Internet intensely and update objects located on desktop. The system registry database (such as Windows registry) is frequently and intensely accessed by many programs in execution. Because conventional technique records all low-level activities and accesses to system resources, log data is generated intensely and in large amount. As shown in FIG. 3, monitoring process state of the Windows XP system on the premise of no Internet connections, 28793 logs of low-level activities are generated within 10 seconds and the number keeps increasing. With reference of FIG. 4, monitoring the Windows XP registry, 2673 logs of accesses are found within 60 seconds and the number also still keeps increasing. These data consumes a lot of system resources yet may be unable to extract high-level crucial clues necessary to investigation.
(3) Conventional monitoring techniques consume large amount of system resources: conventional techniques of monitoring programs in execution and their access to system resources consume lot of system resources due to must keeping the monitoring tools running, collecting and saving log data.
(4) Low efficiency in supporting investigation of lurking program incidents: even such conventional technique that monitors programs in execution and their access to system resources is applied to support investigation of lurking program incidents, the investigators still need to correlate the log data by manual work or other methods. This is not only time consuming but also labor intensive. Moreover, after all these things, high-level crucial clues of the incidents may be still unavailable. Thus the auxiliary effect is quite low.

### SUMMARY OF THE INVENTION

Therefore it is a primary object of the present invention to provide an auxiliary method for investigating lurking program incidents that is used to continuingly monitor a plurality of processes running in a computer system and a system registry database so as to generate process-invoking relationship data and autostart-registered data. After correlation analysis, process-invoking relation logs are generated and saved. Then high-level crucial clues of suspicious lurking programs are extracted and saved. By applying the method according to the present invention, only a little amount of high-level crucial clues and process-invoking relationship logs are collected and a little amount of system resources is consumed. Moreover, the method provides clear evidence that is helpful to investigation of lurking program incidents so that cost of time and labor for collecting and analyzing large amount of low-level logs is dramatically reduced.

In order to achieve above object, the present invention provides an auxiliary method for investigating lurking program incidents. Firstly, keep monitoring a plurality of processes running in a computer system and generate a process-invoking relationship data of each process being monitored when the process is created and terminated. Simultaneously, continuingly monitor a system registry database of the computer system. When a program is registered on an autostart registry area, an autostart-registered data of that area is generated. After getting the process-invoking relationship data and the autostart-registered data, correlate the process-invoking relationship data to the autostart-registered data so as to extract a high-level crucial clues of a suspicious lurking program and the clues are saved into a high-level crucial clue database of the suspicious program. Furthermore, a process-invoking relationship log is generated and is saved in a process-invoking relationship log database.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a prior art that depends on user's judgement to check program security;

FIG. 2 is a conventional browser showing that user's need to decide whether to download ActiveX controls;

FIG. 3 shows huge volume of low-level logs generated by process monitoring of conventional techniques;

FIG. 4 shows huge volume of low-level logs generated by registry database monitoring of conventional techniques;

FIG. 5 shows possible program models of lurking programs according to the present invention;

FIG. 6 is a schematic drawing showing the data flow chart during installing a typical lurking program;

FIG. 7 is a schematic drawing showing the data flow chart during invoking a typical lurking program;

FIG. 8 is a schematic drawing showing the data flow chart of an embodiment according to the present invention;

FIG. 9 is a flow chart showing correlation and analysis processes of an embodiment according to the present invention;

FIG. 10 is process-invoking relationship log and high-level crucial clues of an embodiment according to the present invention;

FIG. 11 is a schematic drawing showing process-invoking relationship among the system service processes of an embodiment according to the present invention;

FIG. 12 is a schematic drawing showing process-invoking relationship of the processes of the application programs being installed with a lurking program of an embodiment according to the present invention;

FIG. 13 is a schematic drawing showing process-invoking relationship among system service processes being installed with a lurking program of an embodiment according to the present invention.

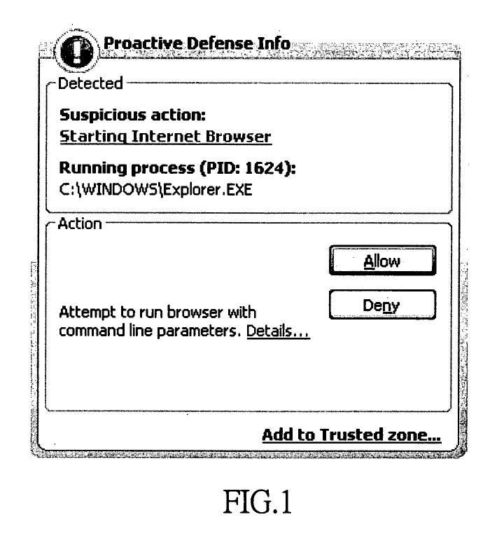

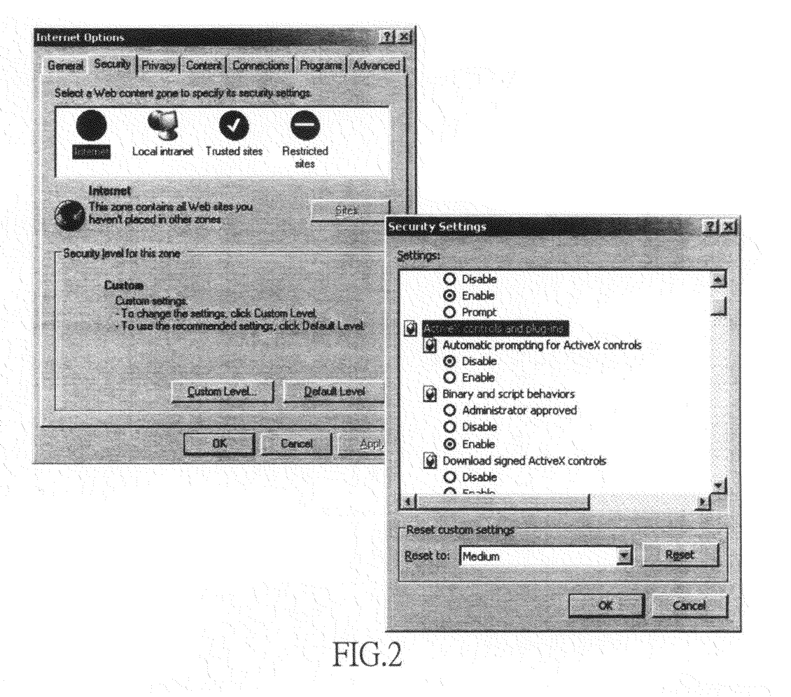

### DETAILED DESCRIPTION OF THE PREFERRED EMBODIMENT

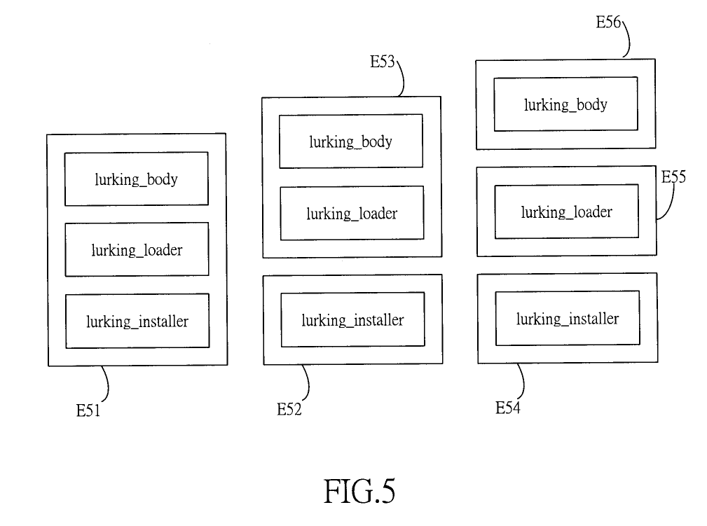

As to an intruded computer system, a lurking program is an external program to it. Before damaging the computer system, the lurking program needs to be installed on the computer system so that it requires a program module—an installer for lurking programs (lurking_installer) that installs the program to the system. Then the lurking program is automatically started by available mechanism in the computer system for performing unauthorized activities. Generally, the installed program module is further divided into a loader for lurking programs (lurking_loader) and a main body (lurking body). The loader is for task at start-up stage and the task is to establish the required environment. The main body of lurking programs performs unauthorized activities. In practice, there are three possible program models of these program modules. Refer to FIG. 5, firstly, these three program modules are designed and integrated into an executable program (E51). Secondly, the installer is designed into an executable program (E52) while the loader and the main body are integrated into another executable program (E53). Finally, each of the three program modules is designed into an executable program (E54, E55, and E56). The above models match our observation based on collecting and analyzing many lurking programs.

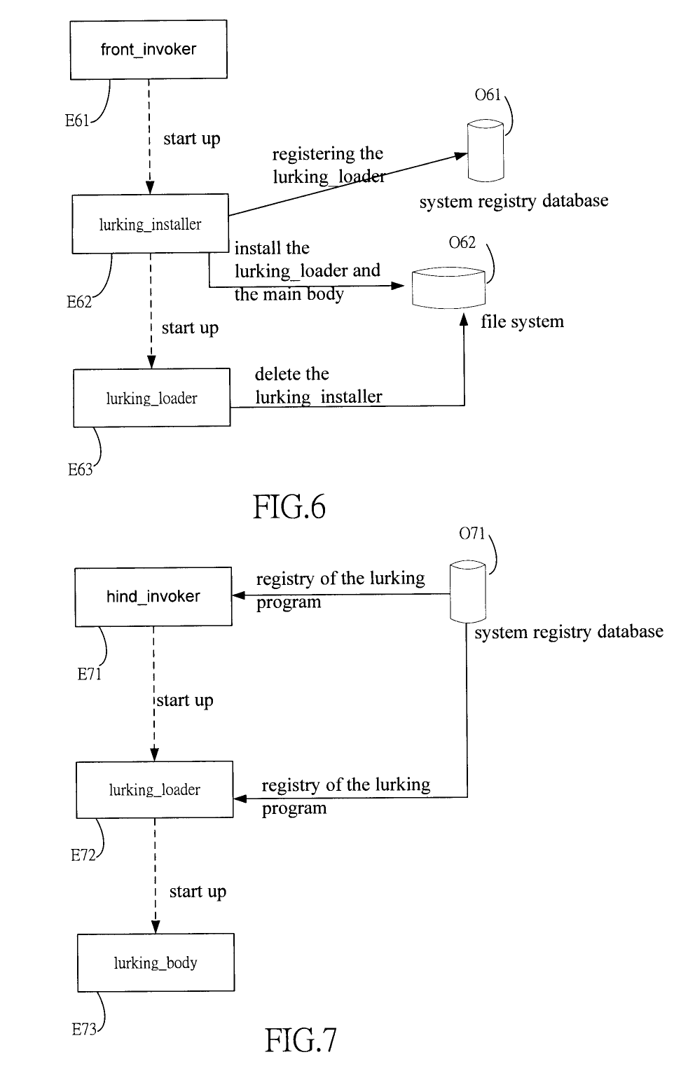

Refer to FIG. 6, a flow chart at an installation stage of the lurking program is revealed. While installing the lurking program, another program that is called a first-line startup program (front_invoker) (E61) is required to invoke the loader for the lurking program. After an installer (E62) being started by the first-line startup program (front_invoker) (E61), the installer (E62) at least needs to finish two things otherwise the installation will not be finished. The first one is registering the loader in a system registry database (O61) while the other is to install the loader and the main body on the file system (O62). The execution order of these two things has no effect on the result. At last, the installer (E62) is possible to start the loader (lurking_loader) (E63) for execution of the lurking program to delete the installer (E62) and prevent being found by the user.

However, the last step is not necessary to be done at installation stage. It can be done at latent stage (FIG. 7), depending on design of the lurking program.

FIG. 7 shows a latent stage of the lurking program. After finishing installation, a specific program in the infected computer system will start it automatically afterwards and this specific program is called second-line startup program (hind_invoker) (E71). The way of installation and registration decides which program becomes the second-line startup program (E71). For example, (1) once the lurking program becomes a system service, the second-line startup program (E71) is a system service manager (services.exe). (2) Once it is executed after log-in, the second-line startup program (E71) is Windows Explorer (explorer.exe). (3) If it becomes a browser extension, the second-line startup program (E71) is the browser. (4) If it becomes a Windows Explorer extension, the second-line startup program (E71) is Windows Explorer. Therefore, when the second-line startup program (E71) runs, it auto start up a loader (E72) of the registered lurking program according to registry of the lurking program in system registry database (O71). After the loader (E72) of the registered lurking program being executed, the main body of the registered lurking program is started according to the registry of the lurking program inside the system registry database (O71). Then the lurking program performs unauthorized activities in a latent way.

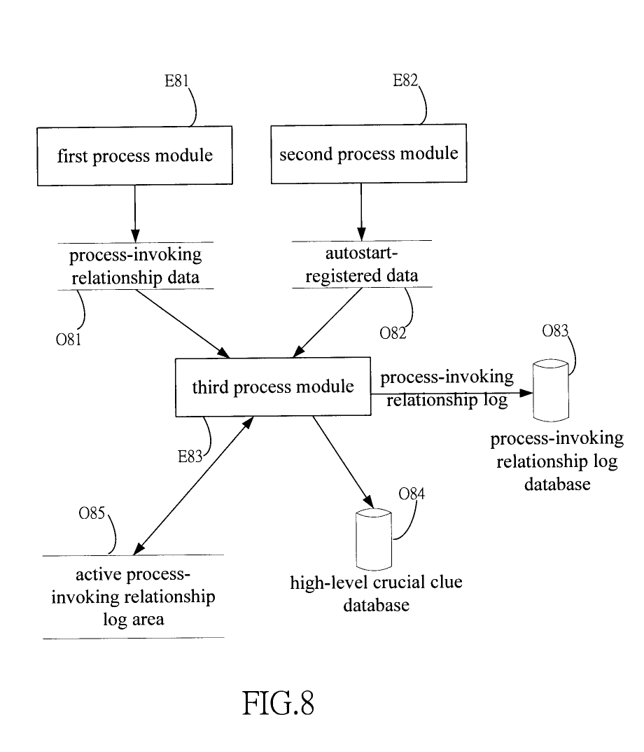

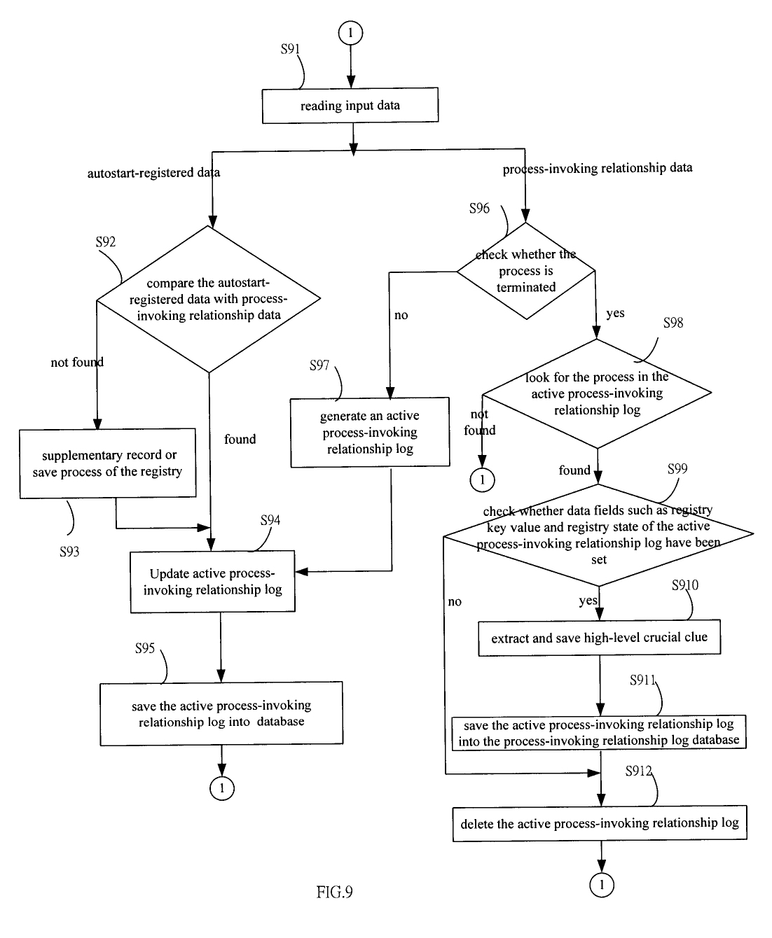

Refer to FIG. 8, an auxiliary method for investigating lurking program incidents of the present invention is disclosed. There are three main process modules: a first process module (E81) for monitoring creation and completion (termination) of processes, a second process module (E82) for monitoring autostart and registration of the programs, and a third process module (E83) for correlation analysis. The first process module (E81) is to monitor all processes and hook system call functions such as process creation, process termination and process deletion in user's computer system. When the first process module (E81) hooks one of the system call functions, the process data is checked by means of built-in system calls so as to generate process-invoking data (O81). Next, the first process module (E81) executes the hooked system call function. The steps of the present method can be run because operating systems all provide information related to the system call functions.

The second process module (E82) is for monitoring autostart registry of all programs in the computer system and hooking system call functions such as new, write, deletion of the system registry database. When the second process module (E82) has hooked one of the system call functions, check whether the registry is on autostart registry area. The way of checking is as following: (1) Get the registry key path from parameters of the hooked functions. (2) Once the path of the registry key doesn't pass any autostart registry area, this means that the monitored process is impossible registered as an autostart program. So it is not important to investigation of the lurking program incident and is able to be neglected.

And then later execute the hooked system call function. (3) If the path of the registry key passes an autostart registry area, an autostart-registered data (O82) is generated. The content of the generated data includes ID of the process and current time got by means of other system call. Then by conversion of parameter of the functions, registry key data (including complete name of a registry key, a registry key value having complete file name of the autostart program) is obtained. And the system call functions are corresponding to registry states such as that once the hooked function is new or write, the registry state is presented as “registration” otherwise the state is “remove registration”. Then the hooked system call function is run.

The autostart registry area includes: system service registry, log-in registry, browser extension registry and Windows explorer extension registry.

The third process module (E83) receives the process-invoking relationship data (O81) from the first process module (E81) and the autostart-registered data (O82) from the second process module (E82). After analysis, if the cross-examination is raised, save the correlated processed data in active process-invoking relationship log area (O85). If the process is going to be terminated (such as process termination and process deletion), the process data is saved from active process-invoking relationship log area (O85) to process-invoking relationship log database (O83) and then high-level data of suspicious lurking program is extracted therefore and is saved into high-level crucial clue database (O84) of suspicious lurking program.

Refer to FIG. 9, a flow chart of the third process module (E83) in FIG. 8 is revealed. Firstly, the third process module (E83) is in a queue for reading input data (S91). Once it gets process-invoking relationship data, check whether the process is terminated (S96). If it gets autostart-registered data, exam the data (S92).

In the step S92, compare the autostart-registered data with process-invoking relationship data in active process-invoking relationship log area (O85 in FIG. 8) and check whether they match with each other. The conditions of matching required to be satisfied are: (1) time: event time of the autostart-registered data is within the process lifetime—from event time of the process creation to event time of the process termination. (2) process: process ID of the process-invoking relationship data is the same with that of the autostart-registered data. (3) registration: the registry state of the autostart-registered data is “registration”. Once the comparison result is “not found”, take the step S93, otherwise run the step S94.

The step S93 is to supplementary record related data of the process that is registering. By checking the process-related data of parent process of the current parent, a process-invoking relationship log is generated and is saved in active process-invoking relationship log area (O85 in FIG. 8). The reason to take the step S93 is in that registration of the autostart program is run earlier than the first process module (E81), the second process module (E82), and the third process module (E83) so that the creation is not monitored and saved yet. Thus the process needs to be supplementary record and then run the step S94.

According to the autostart-registered data read in the step S91, the active process-invoking relationship data found in the step S92 or generated in the step S93 is modified and the modified data fields are registry key value and registry state. After modification, take the step S95, save the active process-invoking relationship data into process-invoking relationship database. Then turn back to the step S91, read the next input data.

In the step S96, according to the process-invoking relationship data read in the step S91, check whether the process is terminated. If not, the process is a new process and take the step S97, generate an active process-invoking relationship log and save the log in the active process-invoking relationship log area (O85 in FIG. 8). Next turn back to the step S95. If the result of the step S96 is yes, it means the process is going to be terminated or deleted, run the step S98.

In the step S98, look for the process in the active process-invoking relationship log area according to process ID of the process. If it is not found, this means the process is run earlier than the first process module (E81), the second process module (E82), and the third process module (E83) and its creation or autostart-registered data is not monitored and saved. Thus the process is not recorded. Next turn back to the step S91, read the data input next. Once the result of the step S98 is yes, it is found, this means the system has ever monitored and saved the process creation or autostart-registered data, further take the step S99.

In the step S99, further check whether data fields such as registry key value and registry state have been set in the active process-invoking relationship log area. If not, this means although the process has been monitored but did not registry in autostart registry yet. Thus there is no installation of the lurking program and take the step S912. If yes, run the step S910.

In the step S912, delete the active process-invoking relationship log of the process, turn back to the step S91, read the data input next.

The step S910 is to extract and save high-level crucial clues. Extract clues helpful to investigate the lurking program incidents such as When-Info, Target-Info, and How-Info from the active process-invoking relationship log and save such high-level crucial clues into a high-level crucial clue database (O84) of the suspicious lurking program. Then run the step S911. The three clues are defined and converted as following: (1) When-Info: includes following item (a) time being installed on the computer system is set as the registered time of the process of the process-invoking relationship log. (2) Target-Info: includes following items (a) a complete file name of the installer of suspicious lurking program is set as complete file name of the process of the process-invoking relationship log. (b) a complete file name of the loader of suspicious lurking program is set as the registry key value of the process-invoking relationship log. (c) a registered address is set as complete name of the registry key of the process-invoking relationship log. (3) How-Info: includes following items (a) a starter of the installer of suspicious lurking program is set as complete file name of the parent process of the process-invoking relationship log. (b) a starter of the loader of suspicious lurking program: complete file name of the starter is determined according to the fact that complete name of the registry key of the process-invoking relationship log is located in the autostart registry area. The way to set the starter is similar to the way to determine which is the second-line startup program (E71) in FIG. 7.

The step S911 is to save the active process-invoking relationship data into the process-invoking relationship log database (O83 in FIG. 8). Then run the step S912, delete active process-invoking relationship log of the process. Next turn back to the step S91, read the data input next.

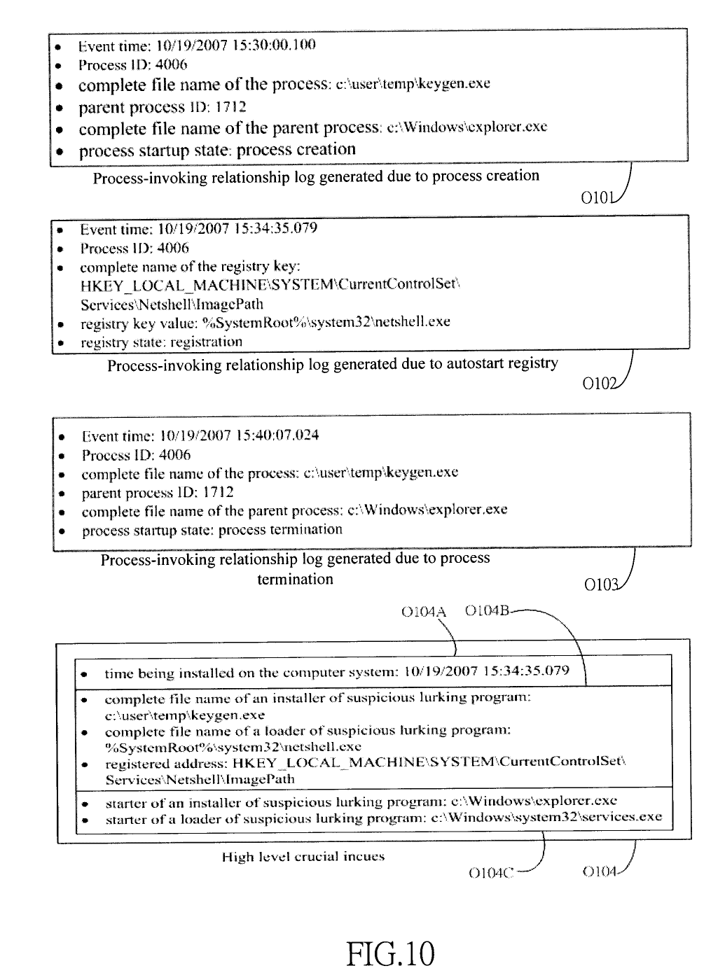

Refer to FIG. 10, an embodiment of the present invention is disclosed to show how the present invention overcomes shortcomings of techniques available now and helps investigate the lurking program incidents. In this embodiment, a user downloads and launches a key generator (keygen.exe) of commercial software from the Internet and is installed with some lurking programs in system service area. There are a few logs and clues generated by the present invention. (1) Process-invoking relationship log (O101) generated due to process creation. (2) Process-invoking relationship log (O102) generated due to autostart registry. (3) Process-invoking relationship log (O103) generated due to process termination. (4) High level crucial clues (O104) having When-Info (O104A), Target-Info (O104B), How-Info (O104C). The present invention monitors the system from a view of installation of lurking programs so that the log generated (such as O101, O102 and O103) and high-level crucial clues (such as O104) is quite precise and high-leveled.

Moreover, the amount of log (such as O101, O102, and O103) and high level crucial clues (such as O104) generated by the present method is quite a few so that the shortcomings of conventional techniques are overcome and only fewer amount of system resources is consumed. From creation to termination, each process only generates at most two process-invoking relationship logs (such as O101 and O103). On the autostart registry, each time each process generates at most a process-invoking relationship log (such as O102) and a high-level crucial clue (such as O104) while registering on the autostart registry area.

Generally, each system service process is started when the system is booted up and is terminated before shot-down of the system. Thus at most each system service process has only two process-invoking relationship logs. Moreover, processes started after log-in and processes started by users are also only a few. For example, for surfing on the Internet, a user only needs to start a browser process. Even he or she has opened a lot of browser windows, the system needs to start only one browser process. Thus, from boot-up to shut-down of the computer system, only a few of processes started by the computer system—mostly between 25 and 200. At other times, each computer system seldom performs registration on the autostart registry area.

Take this embodiment as an example, there are 10 system services started, 3 applications programs started after log-in, and 1 lurking program is installed. Thus, by applying the present invention, data are generated as following: (1) 26 process-invoking relationship log generated due to creation or termination of the process. (2) 1 process-invoking relationship log generated due to autostart registry and 1 high-level crucial clue only.

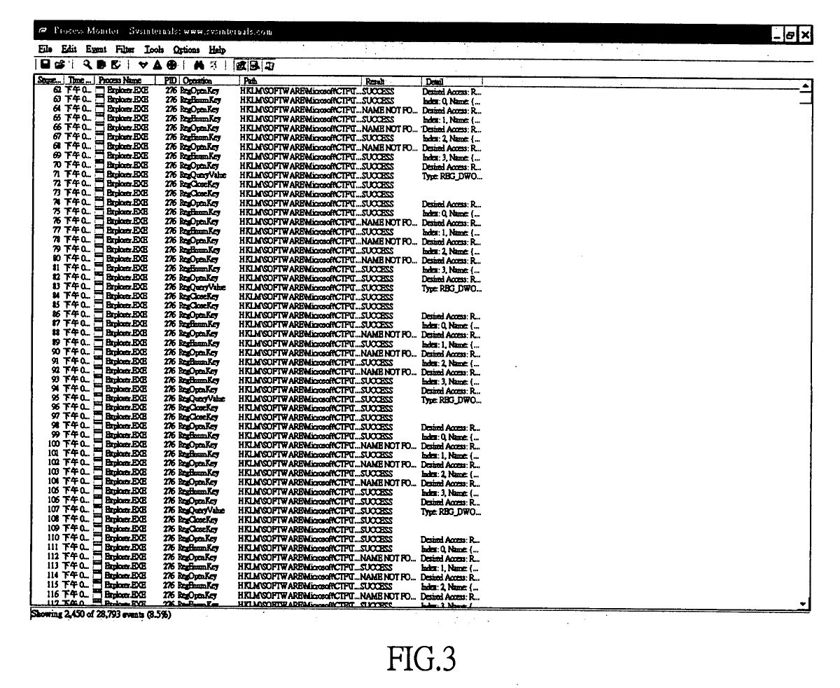

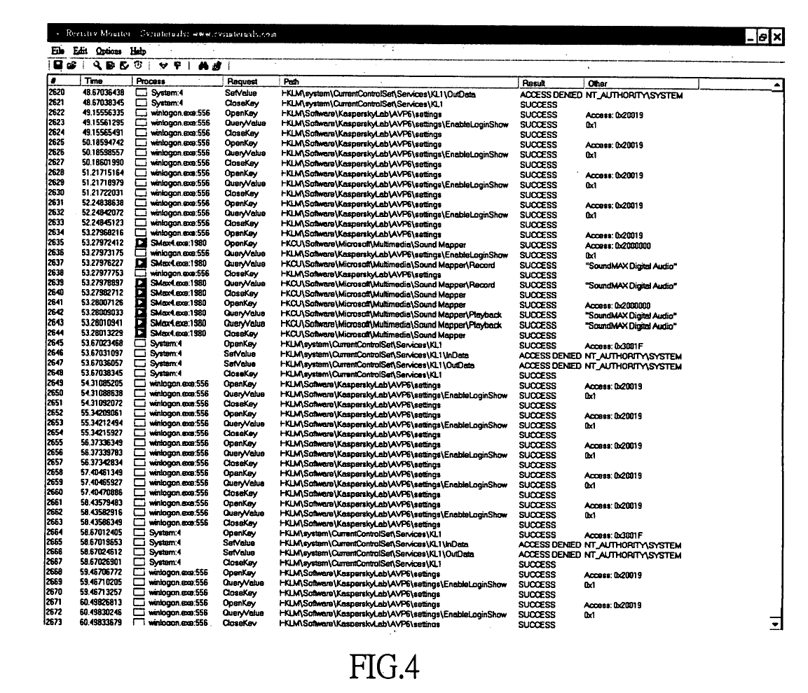

On the contrary, within 60 seconds monitoring of processes state and the system registry database in the Windows system by conventional techniques (as shown in FIG. 3 & FIG. 4), totally 175431 logs are generated (175431=28793×6+2673) and these low-level logs are still keeping generated.

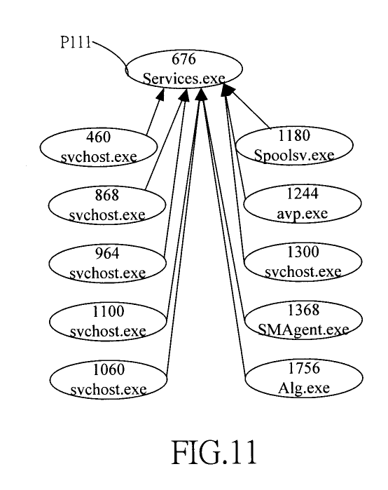

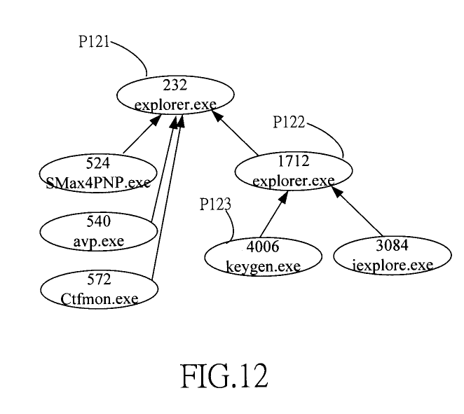

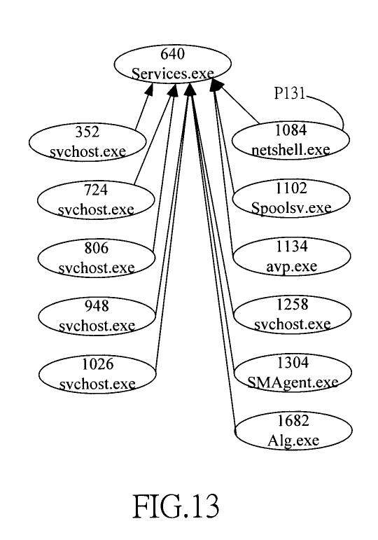

At last, after analyzing process-invoking relationship log and high-level crucial clues generated in the embodiment, results are shown in FIG. 11, FIG. 12 and FIG. 13. Refer to FIG. 11, it shows, after start up of the windows, relationship among the system service processes is obtained from process-invoking relationship log of the system services. It is found that: (1) during start up of the Windows system, which system services are started and executed. (2) all system services are started by a service management process (such as services.exe) (P111).

Refer to FIG. 12, it shows relationship of started processes of the application programs obtained from the process-invoking relationship logs generated by the process started after log-in and the process being started by the user. It is found that: (1) during start up of the Windows system, which application programs are started and executed. (2) which application programs are started by Windows Explorer process (explorer.exe) (P121, P122). (3) the key generator (keygen.exe) (P123) installed a lurking program (netshell.exe) on the system service area (as P131 in FIG. 13).

Refer to FIG. 13, after the user using the key generator (keygen.exe) (P123 in FIG. 12) and the start-up, the relationship chart of system service processes obtained from the process starting related logs of the system service is disclosed. Comparing FIG. 11 with FIG. 13, it is found clearly that a suspicious lurking program is installed on the system service area (P131 in FIG. 13) of the Windows system. Then with reference of the high-level crucial clue (O104 in FIG. 10), it is known that: (1) When-Info (such as O104A in FIG. 10): (a) time being installed on the computer system: 10/19/2007 15:34:35.079. (2) Target-Info (such as O104B in FIG. 10): (a) complete file name of the installer of suspicious lurking program: c:\user\temp\ keygen.exe (b) complete file name of the loader of the suspicious lurking program: %SystemRoot%\system32\netshell.exe (c) registered address: HKEY_LOCAL_MACHINE\SYSTEM\CurrentControlSet\Services\Netshell\ImagePath. (3) How-Info (such as O104C in FIG. 10): (a) starter of the installer of the suspicious lurking program: c:\Windows\explorer.exe (b) starter of the loader of the suspicious lurking program: c:\Windows\system32\ services.exe.

In summary, the process-invoking relationship logs, the high-level crucial clues and the process starting relationship charts obtained from an embodiment of the present invention are helpful to investigate the lurking program incident. By means of less time and labor, suspicious points are limited on programs being installed on the autostart registry area. Moreover, the high-level crucial clues got by the present invention provide evidence for investigators of lurking program incidents so as to help them to find out most suspicious lurking programs. By further analysis and observation, the main culprit of the issue is confirmed.

Therefore, an auxiliary method for investigating lurking program incidents according to the present invention is helpful to investigation of lurking program incidents. It not only saves a lot of labor for collecting data and analysis afterwards but also directly generates high-level crucial clues helpful to investigate lurking program incidents such as When-Info, Target-Info and How-Info without incurring the shortcomings of conventional techniques.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An auxiliary method for investigating lurking program incidents comprising the steps of:
continuously monitoring a plurality of processes run by a computer system and generating a process-invoking relationship data of each of the process being monitored when the process is created and terminated;
continuously monitoring a system registry database of the computer system and when a process is registered on an autostart registry area, an autostart-registered data of the autostart registry area is generated;
correlating the process-invoking relationship data to the autostart-registered data;
extracting high-level crucial clues of a suspicious lurking program and saving the high-level crucial clues of the suspicious lurking program into a high-level crucial clue database of the suspicious program according to the results of correlation; and
generating a process-invoking relationship log and saving the process-invoking relationship log in a process-invoking relationship log database according to the results of correlation.

2. The method as claimed in claim 1, wherein the process-invoking relationship data comprising:
an event time;
a process information having a process ID and a complete file name of the process;
a parent process information having a parent process ID and a complete file name of the parent process; and
a process startup state that represents creation or termination of the process.

3. The method as claimed in claim 1, wherein the autostart registry area comprising:
a log-in registry that is auto started only after log-in;
a system service registry;
a browser extension registry;
a Windows Explorer extension registry; and
a startup registry of a typical file.

4. The method as claimed in claim 1, wherein the autostart-registered data comprising:
an event time;
a process information having a process ID;
a registry key having a complete name thereof and a registry key value, wherein the registry key value having a complete file name of the autostart program; and
a registry state that is labeled as “registration” or “remove registration”.

5. The method as claimed in claim 1, wherein conditions for correlating the process-invoking relationship data to the autostart-registered data comprising:
time: event time of the autostart-registered data is within lifetime—from event time of the process creation to event time of the process termination of the process;
process: process ID of the process-invoking relationship data is the same with process ID of the autostart-registered data; and
registry state: the registry state of the autostart-registered data is “registration”.

6. The method as claimed in claim 1, wherein the process-invoking relationship log comprising:
a time information having time of process creation, time of process termination and time of process registered;
a process information having a process ID and a complete file name of the process;
a patent process information having a parent process ID and a complete file name of the patent process;
a registry key information of the process having a complete name of the registry key and a registry key value; and
a registry state of the process that is labeled as “registration” or “remove registration”.

7. The method as claimed in claim 1, wherein the high-level crucial clues comprising:
a time clue (When-Info) having:
time of being installed on the computer system is set as registered time of the process of the process-invoking relationship log;
an installed target clue (Target-Info) having:
a complete file name of an installer of the suspicious lurking program is set as complete file name of the process of the process-invoking relationship log;
a complete file name of a loader of the suspicious lurking program is set as registry key value of the process-invoking relationship log;
a registered address is set as complete name of the registry key of the process-invoking relationship log;
a starter clue (How-Info) having:
a starter of an installer of the suspicious lurking program is set as complete file name of the parent process of the process-invoking relationship log; and
a starter of a loader of the suspicious lurking program: a complete file name of the starter is set according to the complete name of the registry key of the process-invoking relationship log being in an autostart registry area.

8. The method as claimed in claim 7, wherein setting of the starter clue (How-Info) of the starter of the loader of the suspicious lurking program depends on a complete name of the registry key of the process-invoking relationship log as well as the complete name of the registry key of the process-invoking relationship log being in an autostart registry area and comprising conditions of:
once the complete name of the registry key of the process-invoking relationship log is in a log-in registry area, the starter of the loader of the suspicious lurking program is set as Windows Explorer (explorer.exe);
once the complete name of the registry key of the process-invoking relationship log is in a system service registry, the starter of the loader of the suspicious lurking program is set as service management process (services.exe);
once the complete name of the registry key of the process-invoking relationship log is in a browser extension registry, the starter of the loader of the suspicious lurking program is set as complete file name of the browser;
once the complete name of the registry key of the process-invoking relationship log is in a Windows Explorer extension registry, the starter of the loader of the suspicious lurking program is set as complete file name of the Windows Explorer;
once the complete name of the registry key of the process-invoking relationship log is in a startup registry of a typical file, the starter of the loader of the suspicious lurking program is set as complete file name of the Windows Explorer.

9. The method as claimed in claim 1, wherein the step of continuously monitoring a plurality of processes run by a computer system further comprising the steps of:
hooking system call functions such as process creation, process termination and process deletion of an operation system;
obtaining process-invoking relationship data of the process by means of other system calls when intercepting any one of the hooked system call functions that is being called, then executing the intercepted system call function.

10. The method as claimed in claim 1, wherein the step of continuously monitoring a system registry database of the computer system comprising the steps of:
hooking system call functions such as new, write, deletion of a registry key of an system registry database of an operation system;
checking whether a complete name of a registry key is on the autostart registry area when intercepting any one of the hooked system call functions that is being called;
if not, executing the intercepted system call function; and if yes, generating an autostart-registered data including process ID of the process and current time obtained from other system calls; then converting parameter of the intercepted system call function to get registry key information, and corresponding the intercepted system call function to registry state, next executing the intercepted system call function.
